(19) United States
(12) Patent Application Publication
(10) Pub. No.: US 2024/0354147 A1
(43) Pub. Date: Oct. 24, 2024

(54) Method and Apparatus for VM Scheduling

(71) Applicant: Telefonaktiebolaget LM Ericsson (publ), Stockholm (SE)

(72) Inventor: Ming Jin, Shanghai (CN)

(21) Appl. No.: 18/685,760

(22) PCT Filed: Jul. 13, 2022
(86) PCT No.: PCT/CN2022/105468

§ 371 Date: Feb. 22, 2024

(30) Foreign Application Priority Data
Aug. 31, 2021 (WO) PCT/CN2021/115710

(51) Int. Cl. G06F 9/455; G06F 9/50

(52) U.S. Cl. CPC G06F 9/45558; G06F 9/5027; G06F 2009/45562; G06F 2009/45595; G06F 2209/503

(57) ABSTRACT

Embodiments of the present disclosure provide method and apparatus for virtual machine (VM) scheduling. A method performed by a first network node comprises receiving a request for creating and starting a virtual machine (VM) in a network from a second network node. The request comprises at least one group identifier.

### TECHNICAL FIELD

The non-limiting and exemplary embodiments of the present disclosure generally relate to the technical field of communications, and specifically to methods and apparatuses for virtual machine (VM) scheduling.

### BACKGROUND

This section introduces aspects that may facilitate a better understanding of the disclosure. Accordingly, the statements of this section are to be read in this light and are not to be understood as admissions about what is in the prior art or what is not in the prior art.

Network Functions Virtualization (NFV) is a network architecture concept that uses the technologies of IT (information technology) virtualization to virtualize entire classes of network node functions into building blocks that may connect, or chain together, to create communication services.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The NFV framework may comprise components such as:
network functions (VNFs) are software implementations of network functions that can be deployed on a network functions virtualization infrastructure (NFVI).
functions virtualization infrastructure (NFVI) is the totality of all hardware and software components that build the environment where VNFs are deployed. The NFV infrastructure can span several locations. The network providing connectivity between these locations is considered as part of the NFV infrastructure.
functions virtualization management and orchestration architectural framework (NFV-MANO) is the collection of all functional blocks, data repositories used by these blocks, and reference points and interfaces through which these functional blocks exchange information for the purpose of managing and orchestrating NFVI and VNFs.

VIM (Virtualized Infrastructure Manager) is a software component of NFVI. VIM is responsible for controlling and managing the NFV infrastructure (NFVI) compute, storage, and network resources, usually within one operator's infrastructure domain.

NFVI resources under consideration are both virtualized and non-virtualized resources, supporting virtualized network functions and partially virtualized network functions.

Virtualized resources in-scope are those that can be associated with virtualization containers, and have been catalogued and offered for consumption through appropriately abstracted services, for example:
Compute including machines (e.g. hosts or bare metal), and virtual machines, as resources that comprise both processor and memory.
Storage, including: volumes of storage at either block or file-system level.
Network, including: networks, subnets, ports, addresses, links and forwarding rules, for the purpose of ensuring intra—and inter-VNF connectivity.

ETSI (European Telecommunications Standards Institute) GS (group specification) NFV-IFA (Infrastructure and Architecture) 011 V4.2.1, the disclosure of which is incorporated by reference herein in their entirety, provides requirements for the structure and format of a VNF Package to describe the VNF properties and associated resource requirements in an interoperable template. It focuses on VNF packaging, meta-model descriptors (e.g. VNFD) and package integrity and security considerations.

ETSI GS NFV-IFA 007 V4.2.1, the disclosure of which is incorporated by reference herein in their entirety, specifies the interfaces supported over the Or-Vnfm reference point of the Network Functions Virtualization Management and Orchestration (NFV-MANO) architectural framework ETSI GS NFV-MAN 001 V1.1.1, the disclosure of which is incorporated by reference herein in their entirety, as well as the information elements exchanged over those interfaces.

ETSI GS NFV-SOL 001 V3.3.1, the disclosure of which is incorporated by reference herein in their entirety, specifies a data model for NFV descriptors, using the TOSCA-Simple-Profile-YAML-v1.3, fulfilling the requirements specified in ETSI GS NFV-IFA 011 and ETSI GS NFV-IFA 014 for a Virtualized Network Function Descriptor (VNFD), a Network Service Descriptor (NSD) and a Physical Network Function Descriptor (PNFD). The present document also specifies requirements on the VNFM and NFVO specific to the handling of NFV descriptors based on the TOSCA-Simple-Profile-YAML-v1.3.

ETSI GS NFV-SOL 003 V3.3.1, the disclosure of which is incorporated by reference herein in their entirety, specifies a set of RESTful protocols and data models fulfilling the requirements specified in ETSI GS NFV-IFA 007 for the interfaces used over the Or-Vnfm reference point, except for the “Virtualized Resources Management interfaces in indirect mode” as defined in clause 6.4 of ETSI GS NFV-IFA 007.

ETSI GS NFV-SOL, 006 V3.3.1, the disclosure of which is incorporated by reference herein in their entirety, specifies the YANG models for representing Network Functions Virtualization (NFV) descriptors, fulfilling the requirements specified in ETSI GS NFV-IFA 011 and ETSI GS NFV-IFA 014 applicable to a Virtualized Network Function Descriptor (VNFD), a Physical Network Functions Descriptor (PNFD) and a Network Service Descriptor (NSD).

There are some problems of existing NFV solutions. For example, in nowadays data center who holds NFV network, there is no solution for VIM to schedule VNF VMs with underlay network topology considered. This may result in that VMs, who belong to same VNF, may communicate with each other via a top-tier switch (such as spine switch) when they are unluckily instantiated on compute nodes connected to different bottom-tier switches (such as leaf switches) by VIM. This situation will cause higher network latency of the VNF internal traffic and heavier load on top-tier switch.

Moreover, in none-SDN (Software Defined Network) controlled data center, if VNF internal traffic goes through a top-tier switch, the VNF internal MAC (Medium Access Control) address will be cached in MAC address table of the top-tier switch. Usually the hardware of the top-tier switch has fixed MAC address table, and traffic throughput will be highly impacted when MAC address table was overflown. Moreover VNF provides micro-service, usually has smaller flavor but larger quantity VMs, which means more internal MAC addresses. Then the data center who holds micro-service VNFs may encounter the top-tier switches' MAC address table overflown issue and must increase the number of top-tier switches to avoid this problem. Then the CAPEX (Capital Expenditure) will be increased.

Existing “affinity” mechanism, which can be referred to “affinity-or-anti-affinity-group” in VNF's deployment flavor of ETSI GS NFV-SOL 006 V3.3.1, chapter 6.2, VNFD YANG Module definitions, can't solve this problem. The reason is that this mechanism can only schedule VMs from same “affinity-or-anti-affinity-group” with “affinity” policy on same compute node. On one hand, single compute node has limited compute resource, much lesser than the requirement of normal VNF. On another hand, VNF VMs booting on same compute node will result in weak high availability. So, solution relay on this mechanism won't help VNF VMs with heavy internal communication to be scheduled on compute nodes under same bottom-tier switch.

To overcome or mitigate at least one above mentioned problems or other problems, an improved solution of VM scheduling may be desirable.

In an embodiment, when VIM schedules VMs from same VNF to compute nodes under same bottom-tier switch or bottom-tier switch pairs, VNF internal traffic won't go through top-tier switches. When the compute resources from compute nodes under same bottom-tier switch(es) are insufficient for instantiating all VNF VMs, the VIM will involve as less bottom-tier switches as possible when scheduling VNF VMs.

In an embodiment, when VIM is instantiating a VM, for each candidate compute node, it calculates the total network cost (e.g. distance) score between the candidate compute node and the compute nodes where the rest of the VMs, that belong to the same “network affinity group(s)” as instantiating VM, are hosted. Then VIM selects the compute node who has least total network cost score to instantiate the VM.

In a first aspect of the disclosure, there is provided a method performed by a first network node. The method comprises receiving a request for creating and starting a virtual machine (VM) in a network from a second network node. The request comprises at least one group identifier.

In an embodiment, the at least one group identifier is used for determining a compute node to instantiate the VM.

In an embodiment, the method further comprises determining at least one compute node that has instantiated at least one VM in at least one group identified by the at least one group identifier based on the at least one group identifier.

In an embodiment, the method further comprises computing a total network cost between a candidate compute node and the at least one compute node.

In an embodiment, the method further comprises determining a compute node from one or more candidate compute nodes to instantiate the VM based on respective total network costs computed for each of the one or more candidate compute nodes.

In an embodiment, the total network cost between the determined compute node and the at least one compute node is lowest among the respective total network costs computed for the one or more candidate compute nodes.

In an embodiment, a network cost between a candidate compute node and a compute node is configured with a weight.

In an embodiment, the total network cost comprises at least one of a total network distance, a total network latency, or total network resource consumption.

In an embodiment, the method further comprises determining one from one or more candidate compute nodes to instantiate the VM when the VM is a first VM to be instantiated in at least one group identified by the at least one group identifier.

In an embodiment, the method further comprises creating and starting the VM on a compute node.

In an embodiment, at least one group identified by the at least one group identifier comprises at least one network affinity group.

In an embodiment, VMs in a network affinity group have heavy internal traffic between each other.

In an embodiment, the network comprises a data center network.

In an embodiment, the data center network comprises a spine-and-leaf network.

In an embodiment, a candidate compute node is required to satisfy a predefined condition.

In an embodiment, the predefined condition comprises at least one of resource requirement, or an affinity-or-anti-affinity policy.

In an embodiment, the second network node comprises at least one of a Network Functions Virtualization Orchestrator or a Virtual Network Function manager.

In an embodiment, the first network node comprises a Virtualized Infrastructure Manager.

In a second aspect of the disclosure, there is provided a method performed by a second network node. The method comprises sending a request for creating and starting a virtual machine (VM) in a network to a first network node. The request comprises at least one group identifier.

In an embodiment, the at least one group identifier is used for determining a compute node to instantiate the VM.

In an embodiment, at least one group identified by the at least one group identifier comprises at least one network affinity group.

In an embodiment, VMs in a network affinity group have heavy internal traffic between each other.

In an embodiment, the network comprises a data center network.

In an embodiment, the data center network comprises a spine-and-leaf network.

In an embodiment, the second network node comprises at least one of a Network

Functions Virtualization Orchestrator, or a Virtual Network Function manager.

In an embodiment, the first network node comprises a Virtualized Infrastructure Manager.

In a third aspect of the disclosure, there is provided a first network node. The first network node comprises a processor and a memory coupled to the processor. Said memory contains instructions executable by said processor. Said first network node is operative to receive a request for creating and starting a virtual machine (VM) in a network from a second network node. The request comprises at least one group identifier.

In an embodiment, said first network node is further operative to determine at least one compute node that has instantiated at least one VM in at least one group identified by the at least one group identifier based on the at least one group identifier.

In an embodiment, said first network node is further operative to compute a total network cost between a candidate compute node and the at least one compute node.

In an embodiment, said first network node is further operative to determine a compute node from one or more candidate compute nodes to instantiate the VM based on respective total network costs computed for each of the one or more candidate compute nodes.

In an embodiment, said first network node is further operative to create and start the VM on a compute node.

In an embodiment, said first network node is further operative to determine one from one or more candidate compute nodes to instantiate the VM when the VM is a first VM to be instantiated in at least one group identified by the at least one group identifier.

In a fourth aspect of the disclosure, there is provided a second network node. The second network node comprises a processor and a memory coupled to the processor. Said memory contains instructions executable by said processor. Said second network node is operative to send a request for creating and starting a virtual machine (VM) in a network to a first network node. The request comprises at least one group identifier.

In a fifth aspect of the disclosure, there is provided a first network node. The first network node comprises a receiving module configured to receive a request for creating and starting a virtual machine (VM) in a network from a second network node. The request comprises at least one group identifier.

In an embodiment, the first network node further comprises a first determining module configured to determine at least one compute node that has instantiated at least one VM in at least one group identified by the at least one group identifier based on the at least one group identifier.

In an embodiment, the first network node further comprises a computing module configured to compute a total network cost between a candidate compute node and the at least one compute node.

In an embodiment, the first network node further comprises a second determining module configured to determine a compute node from one or more candidate compute nodes to instantiate the VM based on respective total network costs computed for each of the one or more candidate compute nodes.

In an embodiment, the first network node further comprises a creating and starting module configured to create and start the VM on a compute node.

In an embodiment, the first network node further comprises a third determining module configured to determine one from one or more candidate compute nodes to instantiate the VM when the VM is a first VM to be instantiated in at least one group identified by the at least one group identifier.

In a sixth aspect of the disclosure, there is provided a second network node. The second network node comprises a sending module configured to send a request for creating and starting a virtual machine (VM) in a network to a first network node. The request comprises at least one group identifier.

In a seventh aspect of the disclosure, there is provided a computer program product comprising instructions which, when executed on at least one processor, cause the at least one processor to carry out any of the methods according to the first and second aspects of the disclosure.

In an eighth aspect of the disclosure, there is provided a computer-readable storage medium storing instructions which, when executed on at least one processor, cause the at least one processor to carry out any of the methods according to the first and second aspects of the disclosure.

Embodiments herein afford many advantages, of which a non-exhaustive list of examples follows. In some embodiments herein, the proposed solution can ensure that more VMs are scheduled on the same compute node or compute nodes under the same bottom-tier (e.g., leaf) switch. In some embodiments herein, the proposed solution can ensure that more internal traffic will go through shortest path or shorter path, which mean better network quality. In some embodiments herein, the proposed solution can ensure that the least total network cost (distance) are involved in VNF internal traffic. In some embodiments herein, by invoking network cost (distance) scoring algorithm, the first network node such as VIM can instantiate VMs on proper compute nodes to reduce the overall workload on network devices, reduce the average VNF internal traffic latency, and finally optimize whole VNF network quality. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example of two-tiered Spine-and-Leaf network architecture according to an embodiment of the present disclosure;

FIG. 2 shows a NFV reference architectural framework according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 4 shows a flowchart of a method according to another embodiment of the present disclosure;

FIG. 5 shows an example of a possible VNF internal traffic paths in a two-tiered spine-and-leaf network according to an embodiment of the present disclosure;

FIG. 6 shows an example of an initial state of VNF-1 instantiating in a two-tiered spine-and-leaf network according to an embodiment of the present disclosure;

FIG. 7 shows an example of scheduling VM-VNF1-1 of VNF-1 instantiating in a two-tiered spine-and-leaf network according to an embodiment of the present disclosure;

FIG. 8 shows an example of scheduling VM-VNF1-2 of VNF-1 instantiating in a two-tiered spine-and-leaf network according to an embodiment of the present disclosure;

FIG. 9 shows an example of scheduling VM-VNF1-3 of VNF-1 instantiating in a two-tiered spine-and-leaf network according to an embodiment of the present disclosure;

FIG. 10 shows an example of scheduling VM-VNF1-4 of VNF-1 instantiating in a two-tiered spine-and-leaf network according to an embodiment of the present disclosure;

FIG. 11 shows an example of scheduling VM-VNF1-5 of VNF-1 instantiating in a two-tiered spine-and-leaf network according to an embodiment of the present disclosure;

FIG. 12 shows an example of scheduling VM-VNF1-6 of VNF-1 instantiating in a two-tiered spine-and-leaf network according to an embodiment of the present disclosure;

FIG. 13 is a block diagram showing an apparatus suitable for practicing some embodiments of the disclosure;

FIG. 14 is a block diagram showing a first network node according to an embodiment of the disclosure; and

FIG. 15 is a block diagram showing a second network node according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication public or private standards. The network may have any suitable network topology architecture. In the following description, the terms “network” and “system” can be used interchangeably. Furthermore, the communications between two devices in the network may be performed according to any suitable communication protocols, including, but not limited to, the communication protocols as defined by a standard organization such as ETSI or IEEE (Institute of Electrical and Electronic Engineers). For example, the communication protocols may comprise various data center or SDN communication protocols (such as OpenFlow, OpenDaylight, etc.), and/or any other protocols either currently known or to be developed in the future.

The term “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network). SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

References in the specification to “one embodiment,” “an embodiment,” “an example embodiment.” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”. “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs

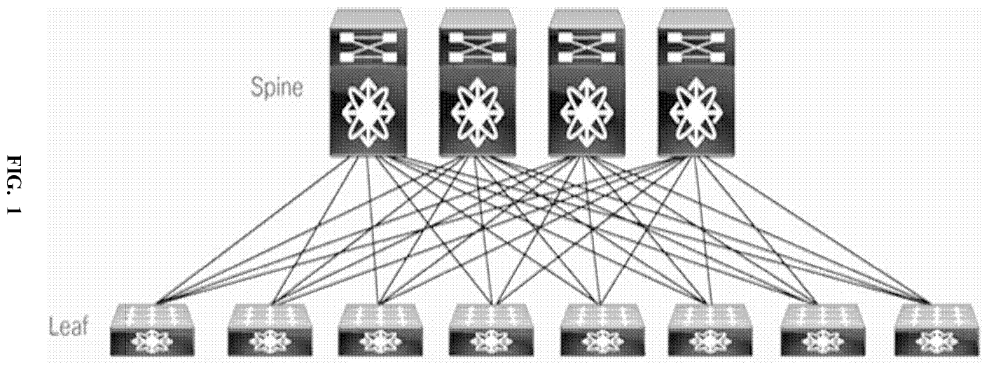

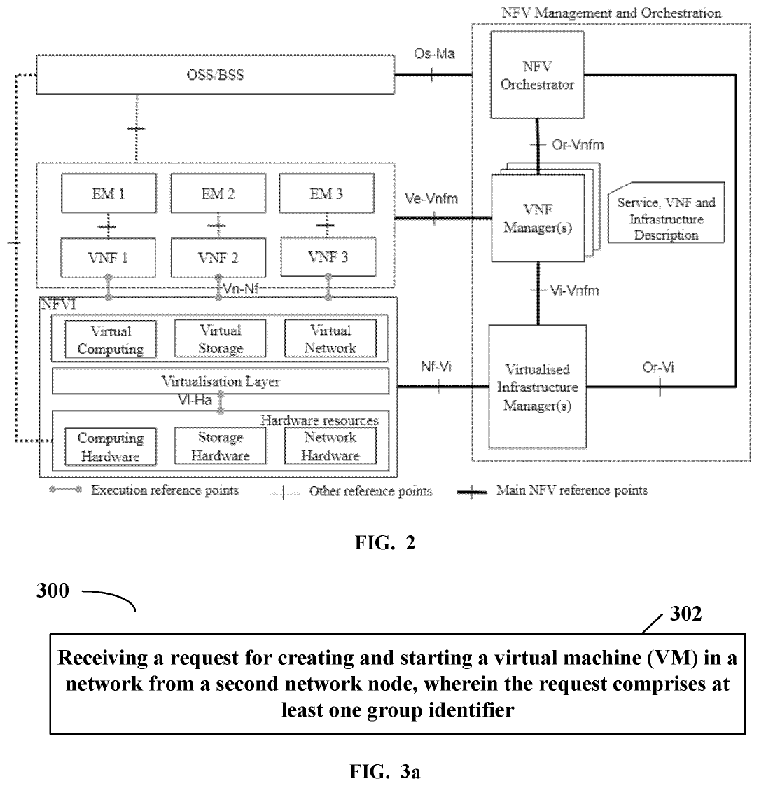

Although the subject matter described herein may be implemented in any appropriate type of system using any suitable components, the embodiments disclosed herein are described in relation to a communication system complied with the exemplary system architecture illustrated in FIGS. 1-2. For simplicity, the system architectures of FIGS. 1-2 only depict some exemplary elements. In practice, a communication system may further include any additional elements suitable to support communication between any two communication devices. The communication system may provide communication and various types of services to one or more customer devices to facilitate the customer devices' access to and/or use of the services provided by, or via, the communication system.

FIG. 1 shows an example of two-tiered Spine-and-Leaf network architecture according to an embodiment of the present disclosure. Typical data center network architecture usually may comprise switches and routers in two—or three-level hierarchy. For example, Spine-and-Leaf network architecture is usually used in large scale data center nowadays, where physical servers connected to leaf switches while leaf switches are aggregated into spine switches. In this two-tier Clos architecture, every lower-tier switch (leaf layer) is connected to each of the top-tier switches (spine layer) in a full-mesh topology. The leaf layer consists of access switches that connect to devices such as servers. The spine layer is the backbone of the network and is responsible for interconnecting all leaf switches. Every leaf switch connects to every spine switch in the fabric. The path is randomly chosen so that the traffic load is evenly distributed among the top-tier switches.

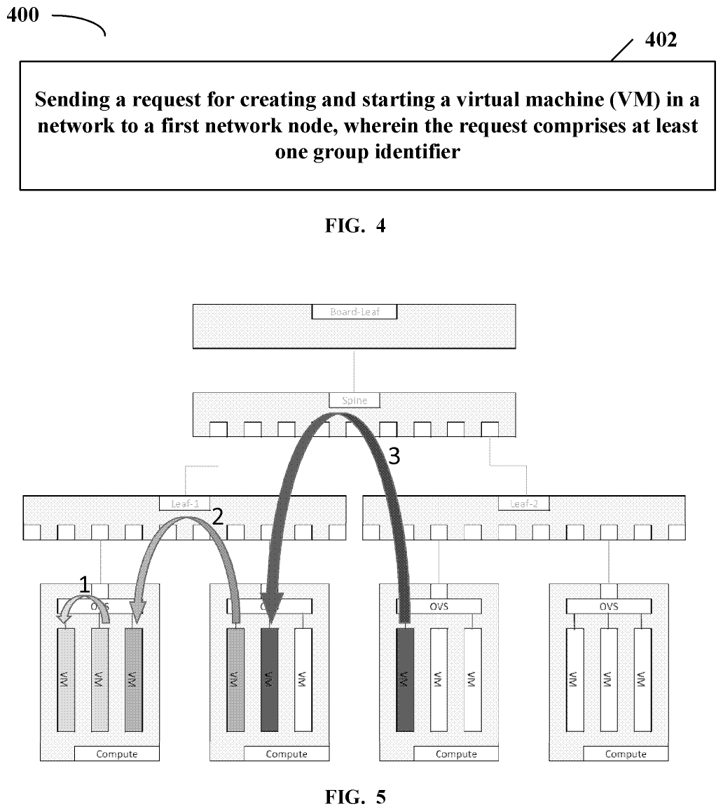

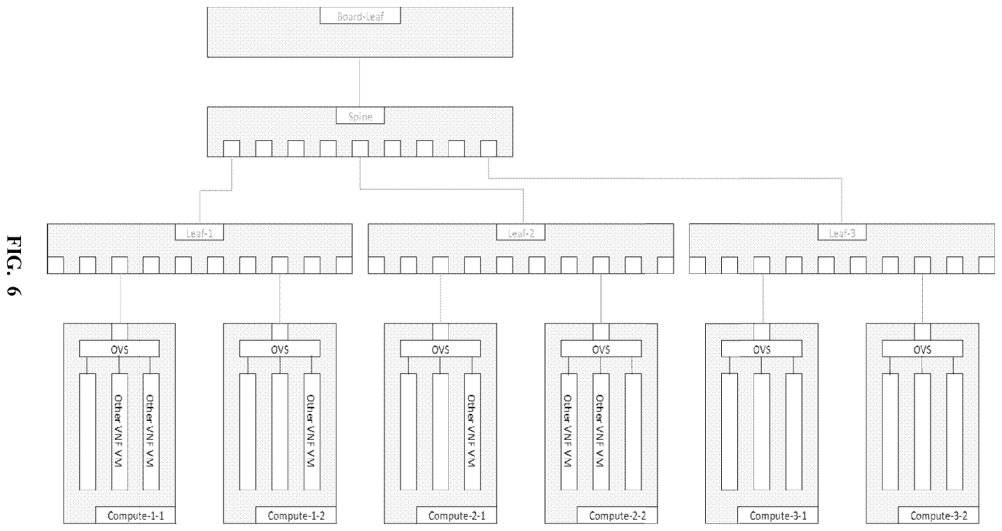

FIG. 2 shows a NFV reference architectural framework according to an embodiment of the present disclosure. FIG. 2 is a copy of FIG. 4 of ETSI GS NFV 002 V1.2.1, the disclosure of which is incorporated by reference herein in their entirety.

The NFV architectural framework identifies functional blocks and the main reference points between such blocks. The functional blocks may comprise:
Virtualized network function (VNF) is a virtualization of a network function in a legacy non-virtualized network. Examples of NFs (network functions) are 3GPP (Third Generation Partnership Project) Evolved Packet Core (EPC) or fifth generation core network (5GC) network elements, e.g. Mobility Management Entity (MME), Serving Gateway (SGW), Packet Data Network Gateway (PGW), AMF, SMF, UPF, UDM; elements in a home network, e.g. Residential Gateway (RGW); and conventional network functions, e.g. Dynamic Host Configuration Protocol (DHCP) servers, firewalls, etc. ETSI GS NFV 001 ETSI GS NFV 001 provides a list of use cases and examples of target network functions (NFs) for virtualization.
Element Management (EM) is a functional block with the main responsibility for FCAPS management functionality for a VNF.
NFV Infrastructure is a functional block representing all the hardware (e.g. compute, storage, and networking) and software, NFV Infrastructure may include:
   Hardware and Virtualized resources, and
   Virtualization Layer.
Virtualized Infrastructure Manager(s) is a functional block with the main responsibility for controlling and managing the NFVI compute, storage and network resources.
NFV Orchestrator is a functional block with two main responsibilities the orchestration of NFVI resources across multiple VIMs, fulfilling the Resource Orchestration (RO) functions described in clause 4.2 of ETSI GS NFV-MAN 001 V1.1.1.
VNF Manager(s) is a functional block with the main responsibility for the lifecycle management of VNF instances as described in clause 4.3 of ETSI GS NFV-MAN 001 V1.1.1.
Service, VNF and Infrastructure Description.
Operations and Business Support Systems (OSS/BSS) is a functional block representing the combination of the operator's other operations and business support functions that are not otherwise explicitly captured in the architectural diagram.

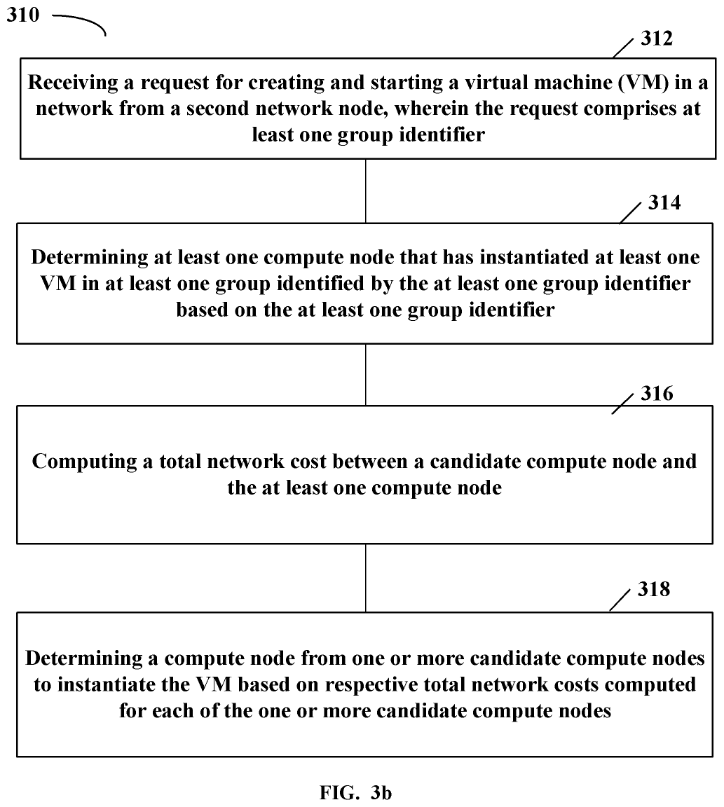

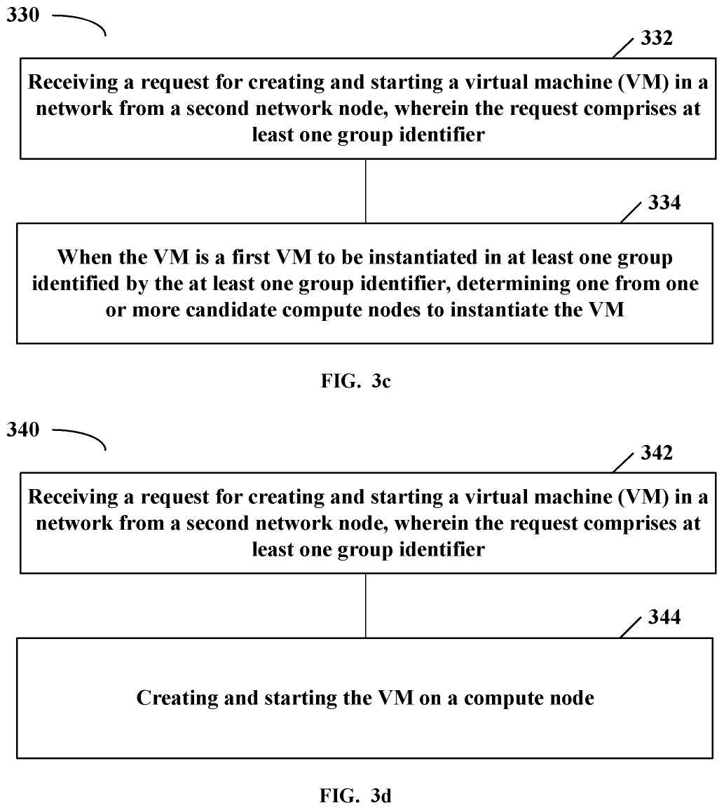

FIG. 3a shows a flowchart of a method according to an embodiment of the present disclosure, which may be performed by an apparatus implemented in or at or as a first network node or communicatively coupled to the first network node. As such, the apparatus may provide means or modules for accomplishing various parts of the method 300 as well as means or modules for accomplishing other processes in conjunction with other components.

At block 302, the first network node may receive a request for creating and starting a virtual machine (VM) in a network from a second network node. The request comprises at least one group identifier. The request may further comprise any other suitable parameters such as the identifier of the second network node, VMs parameters (such as (CPU (Center Processing Unit), Memory, IP (Internet protocol) address, etc.), condition information for determining a compute node to instantiate the VM, etc.

The at least one group identifier may be used for any suitable purpose. In an embodiment, the at least one group identifier is used for determining a compute node to instantiate the VM.

The at least one group identified by the at least one group identifier may be any suitable group. In an embodiment, at least one group identified by the at least one group identifier comprises at least one network affinity group. For example, a network affinity group may be a group which contains VNF VMs who require low latency between each other or require low network distance between each other, etc.

In an embodiment, VMs in a network affinity group have heavy internal traffic between each other.

In an embodiment, a group identifier may be represented by networkAffinityGroup information element.

The second network node may be any suitable network node which requests to instantiate the VNF (such as VM) in a network. In an embodiment, the second network node may comprise at least one of a Network Functions Virtualization Orchestrator or a Virtual Network Function manager as shown in FIG. 2.

The first network node may be any suitable network node which can instantiate the VNF (such as VM) in the network. In an embodiment, the first network node may comprise a Virtualized Infrastructure Manager as shown in FIG. 2.

The network may be any suitable network which can support NFV. In an embodiment, the network may comprise a data center network. The data center network may be any suitable data center network either currently known or to be developed in the future. In an embodiment, the data center network may comprise a spine-and-leaf network.

As described above, VNF is a virtualization of a network function in a legacy non-virtualized network. The network function may be any suitable network function, such as the network function in EPC or 5GC. In other embodiments, the network function may be any other network function in other networks. In an embodiment, the VNF or VNFC comprises a virtual machine (VM).

FIG. 3b shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the first network node may receive a request for creating and starting a virtual machine (VM) in a network from a second network node. The request comprises at least one group identifier. Block 312 is same as block 302 of FIG. 3a.

At block 314, the first network node may determine at least one compute node that has instantiated at least one VM in at least one group identified by the at least one group identifier based on the at least one group identifier. For example, the first network node may store information regarding which compute node has instantiated which VM(s) in which group.

Alternatively this information may be stored in another network node. In the latter case, the first network node may retrieve this information from another network node. By using such information, the first network node may determine at least one compute node that has instantiated at least one VM in at least one group identified by the at least one group identifier based on the at least one group identifier.

At block 316, the first network node may compute a total network cost between a candidate compute node and the at least one compute node. The total network cost can be any suitable network cost. In an embodiment, the total network cost comprises at least one of a total network distance, a total network latency, or total network resource consumption.

The total network cost can be computed by using any suitable method and the present disclosure has no limit on it. For example, the smaller the network distance between two compute nodes is, the smaller the network cost is. The smaller the network latency between two compute nodes is, the smaller the network cost is. The less consumption on network resource, the less network cost is.

In an embodiment, the total network cost may be computed as following.

$$Score = {\sum }_{k = 0}^{n} {D}_{( Ck , C )}$$

k denotes instantiated VM from same network group(s).
Ck denotes compute node who hosting the VM k.
C denotes a candidate compute node.
D_{(Ck,c)} denotes the network cost between a compute node Ck and a candidate compute node C.

In an embodiment, when two or more network cost classes are involved in computation, the total network cost may be computed as following.

$$Score = {\sum }_{j = 1}^{m} {\sum }_{k = 0}^{n} {D ( Ck , C )}_{j}$$

k denotes instantiated VM from same network group(s).
Ck denotes compute node who hosting the VM k.
C denotes a candidate compute node.
j denotes the network cost class.

D(Ck, C)ⱼ denotes the network cost of class j between a compute node Ck and a candidate compute node C.

In an embodiment, a network cost between a candidate compute node and a compute node is configured with a weight. For example, the total network cost may be computed as following.

$$Score = {\sum }_{j = 1}^{m} {\sum }_{k = 0}^{n} {W}_{kj} {D ( Ck , C )}_{j}$$

Wₖⱼ denotes a weight for the D(Ck, C) j. Wₖⱼ may be determined by using any suitable methods.

In an embodiment, a candidate compute node is required to satisfy a predefined condition. The predefined condition may be any suitable condition for example depending on different resource requirement or affinity-or-anti-affinity-group policy, or other scheduling policy specified by VNF VMs.

In an embodiment, the predefined condition comprises at least one of resource requirement or an affinity-or-anti-affinity policy. For example, the candidate compute node may be required to have sufficient resource to instantiate the VM. The candidate compute node may be required to satisfy affinity-or-anti-affinity policy. For example, when anti-affinity policy exists between VM 1 and VM 2, the VM 1 and VM 2 should not be instantiated on the same compute node. When affinity policy exists between VM 3 and VM 4, the VM 3 and VM 4 should be instantiated on the same compute node.

At block 318, the first network node may determine a compute node from one or more candidate compute nodes to instantiate the VM based on respective total network costs computed for each of the one or more candidate compute nodes. For example, the first network node may determine which candidate compute node has the lowest total network cost and then select the candidate compute node having the lowest total network cost to instantiate the VM.

In an embodiment, the total network cost between the determined compute node and the at least one compute node is lowest among the respective total network costs computed for the one or more candidate compute nodes.

In an embodiment, when two or more candidate compute nodes have the lowest total network cost, the first network node may random select one of the two or more candidate compute nodes.

FIG. 3c shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the first network node may receive a request for creating and starting a virtual machine (VM) in a network from a second network node. The request comprises at least one group identifier. Block 332 is same as block 302 of FIG. 3a.

At block 334, the first network node may determine one from one or more candidate compute nodes to instantiate the VM when the VM is a first VM to be instantiated in at least one group identified by the at least one group identifier (i.e., when there is no instantiated VM in at least one group identified by the at least one group identifier). For example, the first network node may random select one of one or more candidate compute nodes to instantiate the VM.

FIG. 3d shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 340 as well as means or modules for accomplishing other processes in conjunction with other components. For some parts which have been described in the above embodiments, the description thereof is omitted here for brevity.

At block 342, the first network node may receive a request for creating and starting a virtual machine (VM) in a network from a second network node. The request comprises at least one group identifier. Block 342 is same as block 302 of FIG. 3a.

At block 344, the first network node may create and start the VM on a compute node. For example, the first network node may allocate the internal connectivity network. The first network node may allocate the needed compute resources and storage resources and attaches instantiated VMs to the internal connectivity network. For example, the compute node may be determined by any suitable method. In an embodiment, the compute node may be determined by the methods 310 or 330.

FIG. 4 shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second network node may send a request for creating and starting a virtual machine (VM) in a network to a first network node. The request comprises at least one group identifier.

The second network node may be triggered to send the request due to various reasons. As a first example, as described in clause B.3.1.2 of ETSI GS NFV-MAN 001 V1.1.1, NFVO may receive a trigger to instantiate a VNF in the network (this can be a manual trigger or an automatic service creation trigger request e.g. from the OSS/BSS) for example using the operation Instantiate VNF of the VNF Lifecycle Management interface. In this case, the second network node such as NFVO may be triggered to send the request (i.e., step 8 of Figure B.9 of ETSI GS NFV-MAN 001 V1.1.1) to the first network node such as VIM.

As a second example, EM requests to the VNF Manager (the second network node) instantiation of a new VNF in the network as described in clause B.3.2.1 of ETSI GS NFV-MAN 001 V1.1.1. In this case, the second network node such as VNF Manager may be triggered to send the request (i.e., step 7 of Figure B.10 of ETSI GS NFV-MAN 001 V1.1.1) to the first network node.

As a third example, the NFVO receives a trigger to instantiate a VNF in the network (this can be a manual trigger or an automatic service creation trigger request e.g. from the OSS/BSS) using the operation Instantiate VNF of the VNF Lifecycle Management interface. NFVO requests to the VNF Manager instantiation of a new VNF in the infrastructure using the operation as described in clause B.3.2.2 of ETSI GS NFV-MAN 001 V1.1.1. In this case, the second network node such as VNF Manager may be triggered to send the request (i.e., step 8 of Figure B.11 of ETSI GS NFV-MAN 001 V1.1.1) to the first network node.

As a fourth example, the NFVO receives a scaling request from a sender, e.g. OSS using the operation Scale VNF of the VNF Lifecycle Management interface. NFVO requests from VIM allocation of changed resources (compute, storage and network) needed for the scaling request using the operations Allocate Resource or Update Resource or Scale Resource of the Virtualized Resources Management interface as described in clause B.4.3 of ETSI GS NFV-MAN 001 V1.1.1. In this case, the second network node such as NFVO may be triggered to send the request (i.e., step 8 of Figure B.12 of ETSI GS NFV-MAN 001 V1.1.1) to the first network node.

As a fifth example, the second network node such as VNF Manager may be triggered to send the request (i.e., step 8 of Figure B.13 of ETSI GS NFV-MAN 001 V1.1.1) to the first network node due to VNF expansion as described in clause B.4.4.1 of ETSI GS NFV-MAN 001 V1.1.1. VNF expansion refers to the addition of capacity that is deployed for a VNF. Expansion may result in a scale out of a VNF by adding VNFCs to support more capacity or may result in a scale-up of virtualized resources in existing VNF/VNFCs. VNF expansion may be controlled by an automatic process or may be a manually triggered operation.

As a sixth example, Manual Operator's request or automatic event to expand the capacity of a virtual node (VNF). EM requests capacity expansion to the VNF Manager using the operation Scale VNF of the VNF Lifecycle Management interface as described in clause B.4.4.2 of ETSI GS NFV-MAN 001 V1.1.1. In this case, the second network node such as VNF Manager may be triggered to send the request (i.e., step 8 of Figure B.14 of ETSI GS NFV-MAN 001 V1.1.1) to the first network node.

The following embodiments shows how to implement the proposed solution in a spine-and-leaf network.

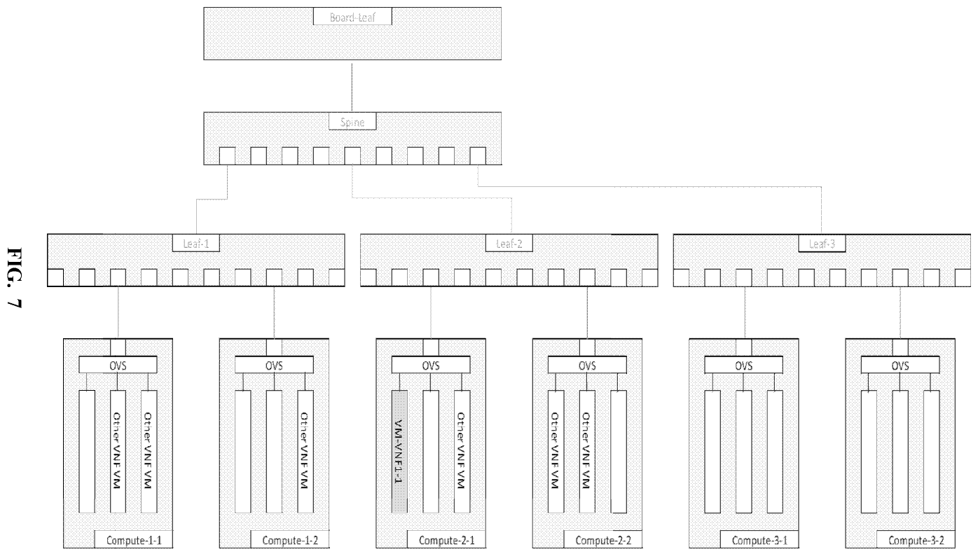

FIG. 5 shows an example of a possible VNF internal traffic paths in a two-tiered spine-and-leaf network according to an embodiment of the present disclosure.

As shown in FIG. 5, VNF VMs may be under many leaf switches. VIM doesn't know VNF's internal traffic details. VIM has no fabric-cared scheduler algorithm. There may be 3 kinds of VNF internal traffic paths existed in the spine-and-leaf network.
Path 1: East-West traffic within same compute node, which passes virtual switch only.
Path 2: East-West traffic goes across different compute nodes connected to same leaf switch.
Path 3: East-West traffic goes across different compute nodes connected to different leaf switches, via spine switch.

Obviously, path 1 has the shortest data path, least workload on network devices and least latency. Path 3 has the longest data path, heaviest workload on network devices and longest latency. Path 2 was in the middle.

If unlucky, VNF's internal traffic may go through path 3. The path 3 may lead to:
Longer data path, e.g., longer internal traffic latency (For VNF)
Heavier workload on network devices, e.g., heavier load on spine and leaf switches (For DC (data center))
MAC address table consumption in spine layer switches in None-SDN network, which may lead to unnecessary expansion of spine layer switches.

FIGS. 6-12 show an example of deploying VNF-1 in a two-tiered spine-leaf network according to an embodiment of the present disclosure. The two-tiered spine-leaf network may be used in a data center (DC). In this embodiment, though the network cost is shown as network distance, other type of network cost is also possible. The number of switches may be any suitable number though only five switches are shown in FIGS. 6-12. The number of compute nodes may be any suitable number though only six compute nodes are shown in FIGS. 6-12.

FIG. 6 shows an example of an initial state of VNF-1 instantiating in a two-tiered spine-and-leaf network according to an embodiment of the present disclosure.

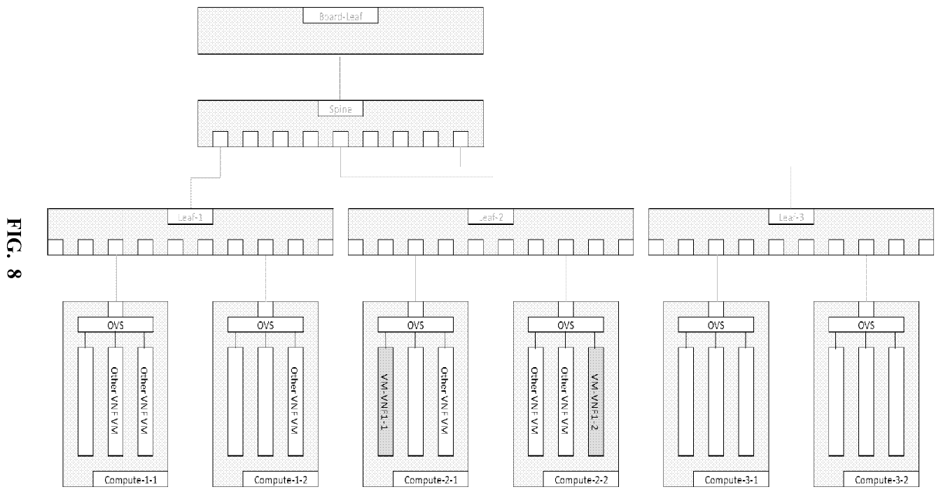

FIG. 7 shows an example of scheduling VM-VNF1-1 of VNF-1 instantiating in a two-tiered spine-and-leaf network according to an embodiment of the present disclosure.

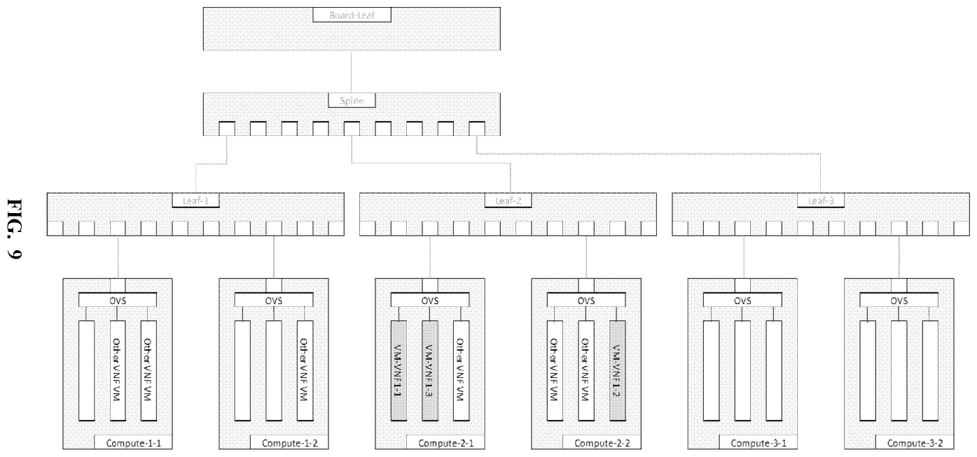

FIG. 8 shows an example of scheduling VM-VNF1-2 of VNF-1 instantiating in a two-tiered spine-and-leaf network according to an embodiment of the present disclosure.

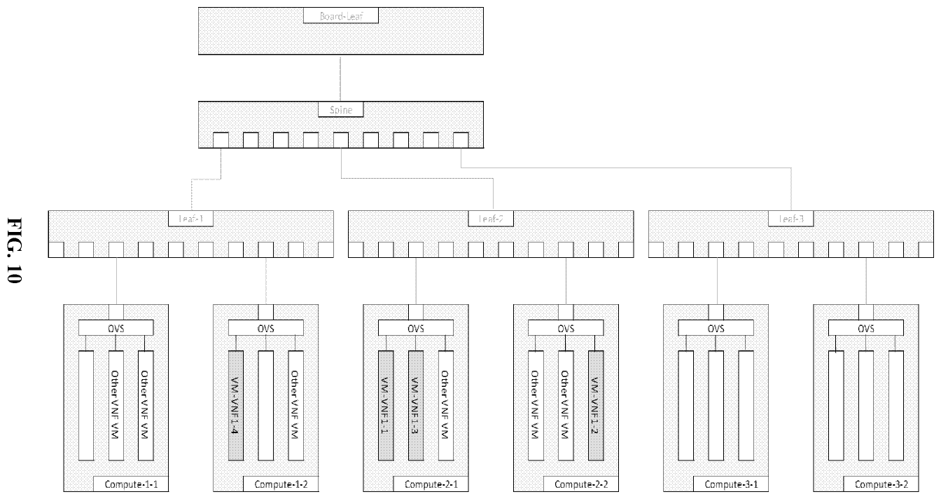

FIG. 9 shows an example of scheduling VM-VNF1-3 of VNF-1 instantiating in a two-tiered spine-and-leaf network according to an embodiment of the present disclosure.

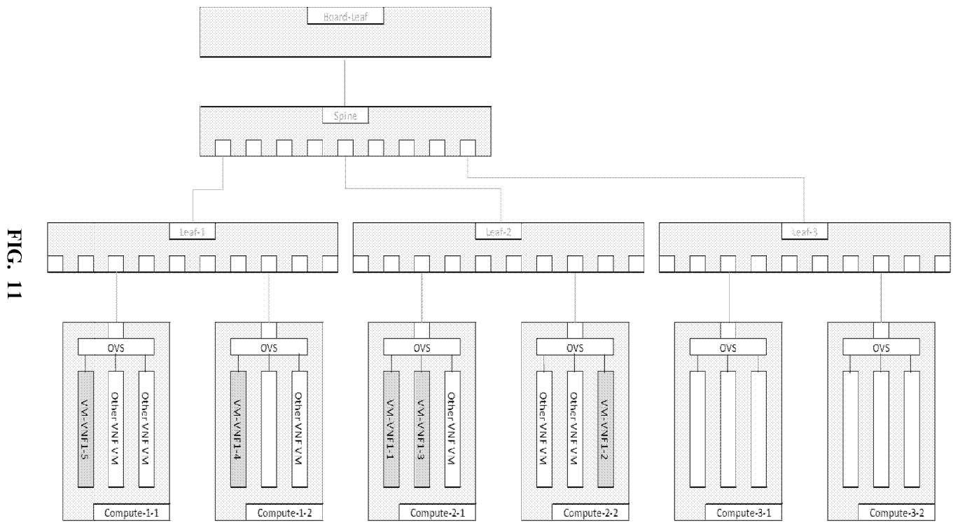

FIG. 10 shows an example of scheduling VM-VNF1-4 of VNF-1 instantiating in a two-tiered spine-and-leaf network according to an embodiment of the present disclosure.

FIG. 11 shows an example of scheduling VM-VNF1-5 of VNF-1 instantiating in a two-tiered spine-and-leaf network according to an embodiment of the present disclosure.

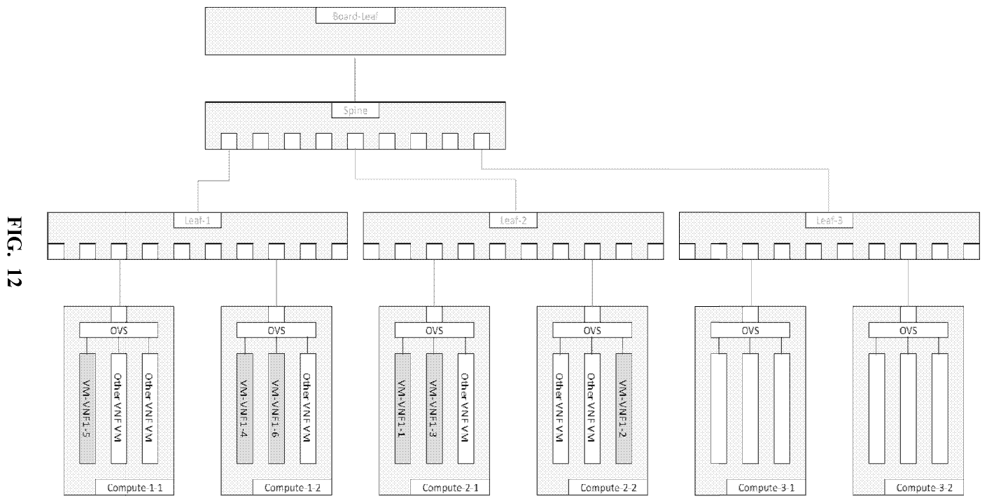

FIG. 12 shows an example of scheduling VM-VNF1-6 of VNF-1 instantiating in a two-tiered spine-and-leaf network according to an embodiment of the present disclosure.

In day-0 configuration, a network distance table inside VIM shall be generated.

This DC has 6 compute nodes, which are connected to 3 leaf layer switch pairs. Each switch pair contains 2 switches but are abstracted as one box. The 3 leaf layer switch pairs connect to spine layer switches, which are also abstracted as one box.

There are already some VMs from other VNF deployed on this DC. The available compute resource is marked as blank boxes inside each compute node. To simply the example, let's assume all VMs from the instantiating VNF have same flavor, and fit for each blank box.

Assuming leaf layer switches “Leaf-1” and “Leaf-2” switch pairs are more advanced than “Leaf-3”. Then a larger network distance value can be configured on compute nodes connected to Leaf-3 switches to indicate lower quality provided by “Leaf-3” switches.

The network distance inside same compute node was set as “1”. The network distance between different compute nodes can be given based on ping's result or by some other measurement.

Then, a network distance table between each compute nodes may be specified as below Table 1.

TABLE 1

| Network | | | | | | |
|---|---|---|---|---|---|---|
| Distance | Compute-1-1 | Compute-1-2 | Compute-2-1 | Compute-2-2 | Compute-3-1 | Compute-3-2 |
| Compute-1-1 | 1 | 10 | 20 | 20 | 25 | 25 |
| Compute-1-2 | 10 | 1 | 20 | 20 | 25 | 25 |
| Compute-2-1 | 20 | 20 | 1 | 10 | 25 | 25 |
| Compute-2-2 | 20 | 20 | 10 | 1 | 25 | 25 |
| Compute-3-1 | 25 | 25 | 25 | 25 | 1 | 15 |
| Compute-3-2 | 25 | 25 | 25 | 25 | 15 | 1 |

In day-1 VNF deployment phase, VNF, named as “VNF1”, is constituted by 6 VMs, will be instantiated on this data center. VNF1's internal traffic exists among all the 6 VMs. And “anti-affinity” policy exists between “VM-VNF1-1” and “VM-VNF1-2”, as well as between “VM-VNF1-4” and “VM-VNF1-5”.

To have a better internal network quality, VNF1 grouped all VMs in same network group. Then it starts to send messages to VIM to instantiate VMs one by one.

When instantiating VM-VNF1-1, all candidate compute nodes have the same network distance score, which is 0. Assuming compute nodes with same score will be selected randomly and “Compute-2-1” is selected for VM-VNF1-1, as illustrated in FIG. 7.

When instantiating VM-VNF1-2, due to the “anti-affinity” policy, Compute-2-1 is filtered out. Then the candidate compute nodes are “Compute-1-1”, “Compute-1-2”, “Compute-2-2”, “Compute-3-1”, and “Compute-3-2”. According to the Table 1, follow the formula shown below to calculate the total network distance score for each candidate compute node.

$$Score = {\sum }_{k = 0}^{n} {D}_{( Ck , C )}$$

k: Instantiated VM in the same network group
Ck: Compute node who hosting the VM k
C: Candidate compute node
D_{(Ck,C)}: Network Distance between Ck and C

The score for each candidate compute node may be like the following Table 2.

TABLE 2

| Total | | | | | | |
|---|---|---|---|---|---|---|
| Network | | | | | | |
| Distance | Compute-1-1 | Compute-1-2 | Compute-2-1 | Compute-2-2 | Compute-3-1 | Compute-3-2 |
| VM-VNF1-2 | 20 | 20 | N/A | 10 | 25 | 25 |

Therefore, “VM-VNF1-2” is scheduled on “Compute-2-2” who has least score, as illustrated in FIG. 8.

When instantiating VM-VNF1-3, due to insufficient resource, Compute-2-2 is filtered out. Then the total network distance score for each candidate compute node may be like the following Table 3.

TABLE 3

| Total | | | | | | |
|---|---|---|---|---|---|---|
| Network | | | | | | |
| Distance | Compute-1-1 | Compute-1-2 | Compute-2-1 | Compute-2-2 | Compute-3-1 | Compute-3-2 |
| VM-VNF1-3 | 40 | 40 | 11 | N/A | 50 | 50 |

Then “VM-VNF1-3” is scheduled on “Compute-2-1” who has the least score, as illustrated in FIG. 9.

When instantiating VM-VNF1-4, due to insufficient resource, Compute-2-1 and Compute-2-2 are filtered out. Then the total network distance score for each candidate compute node may be like the following Table 4.

TABLE 4

| Total | | | | | | |
|---|---|---|---|---|---|---|
| Network | | | | | | |
| Distance | Compute-1-1 | Compute-1-2 | Compute-2-1 | Compute-2-2 | Compute-3-1 | Compute-3-2 |
| VM-VNF1-4 | 60 | 60 | N/A | N/A | 75 | 75 |

Then Compute-1-1 and Compute-1-2 have same score. Assuming “Compute-1-2” is selected and “VM-VNF1-4” is scheduled on Compute-1-2, as illustrated in FIG. 10.

When instantiating VM-VNF1-5, due to the “anti-affinity” policy, Compute-1-2 is filtered out. Due to insufficient resource, Compute-2-1 and Compute-2-2 are filtered out. Then the total network distance score for each candidate compute node may be like the following Table 5.

TABLE 5

| Total | | | | | | |
|---|---|---|---|---|---|---|
| Network | | | | | | |
| Distance | Compute-1-1 | Compute-1-2 | Compute-2-1 | Compute-2-2 | Compute-3-1 | Compute-3-2 |
| VM-VNF1-5 | 70 | N/A | N/A | N/A | 100 | 100 |

Then “VM-VNF1-5” is scheduled on “Compute-1-1” who has the least score, as illustrated in FIG. 11.

When instantiating VM-VNF1-6, due to insufficient resource, Compute-1-1, Compute-2-1 and Compute-2-2 are filtered out. Then the total network distance score for each candidate compute node may be like the following Table 6.

TABLE 6

| Total | | | | | | |
|---|---|---|---|---|---|---|
| Network | | | | | | |
| Distance | Compute-1-1 | Compute-1-2 | Compute-2-1 | Compute-2-2 | Compute-3-1 | Compute-3-2 |
| VM-VNF1-6 | N/A | 71 | N/A | N/A | 125 | 125 |

Then “VM-VNF1-6” is scheduled on “Compute-1-2” who has the least score, as illustrated in FIG. 12.

From this example, it could be seen that with this scheduling algorithm, all VNF1's VMs are scheduled on compute nodes connected to advanced leaf switches. Even Compute-3-1 and Compute-3-2 have abundant compute resource, due to the bad network quality provided by their leaf switches, no VM is scheduled on compute nodes connected to them.

So, this VIM scheduling algorithm can improve VNF network quality.

In an embodiment, VNFD needs to define which VNFCs belong to the same “network affinity group(s)”. VNFM needs to pass the “network affinity group(s)” information to VIM when instantiating the VNFC (e.g., VM). VIM may calculate the network cost (such as network distance) for each VM and place VNF VMs to proper compute nodes. The scheduling algorithm checks the instantiating VM's “network affinity group(s)”, calculates each candidate compute nodes total network cost and then selects compute node who has the least total network cost score to instantiate VM on the selected compute node.

In an embodiment, the proposed scheduling algorithm as well as the interface of “network affinity group” between VIM and VNFM are the focus of this patent disclosure.

In an embodiment, the “network affinity group” is a group which contains VNF VMs who have heavy internal traffic between each other. “Network affinity group” will be introduced in the following specifications:

ETSI GS NFV-IFA 011 V4.1.1:
Introducing “networkAffinityGroup” in “VnfDf information element”.
Introducing “networkAffinityGroupId” in “VduProfile information element”.
Introducing “networkAffinityGroup” in chapter “Information elements related to the DeploymentFlavour”.

ETSI GS NFV-SOL 006 V3.3.1, in its VNFD YANG Module:
Introducing “network-affinity-group” with path “/nfv: nfv/nfv: vnfd/nfv: df/nfv: network-affinity-group”.
Introducing “network-affinity-group-id” with path “/nfv: nfv/nfv: vnfd/nfv: df/nfv: vdu-profile/nfv: network-affinity-group-id”.
Introducing “network-affinity-group” with path “/nfv: nfv/nfv: nsd/nfv: df/nfv: network-affinity-group”.
Introducing “network-affinity-group-id” with path “/nfv: nfv/nfv: nsd/nfv: df/nfv: vnf-profile/nfv: network-affinity-group-id”.

ETSI GS NFV-SOL 001 V3.3.1, introducing “tosca.groups.nfv. NetworkPlacementGroup” in “Group Types”. “tosca.groups nfv. NetworkPlacementGroup” is used for describing the network-affinity relationship applicable between VDUs who hosted the virtualization containers.

The placement constraint could be introduced in the following specifications:

ETSI GS NFV-IFA 011 V4.1.1, introducing “NetworkAffinityRule information element” with constant value “SOFT_NETWORK AFFINITY” in “Information elements related to the DeploymentFlavour” chapter. This element will be used by newly introduced “NetworkAffinityGroup information element”.

ETSI GS NFV-SOL 006 V3.3.1, introducing “network-affinity-type” with constant value “soft-network-affinity” in the type definition of “etsi-nfv-common module”.

ETSI GS NFV-IFA 007, introducing attribute “networkAffinity” with constant value “SOFT_NETWORK_AFFINITY” in “PlacementConstraint information element”.

ETSI GS NFV-SOL 003 V3.3.1, introducing constant value “SOFT_NETWORK_AFFINITY” in “PlacementConstraint information element” in data model of “VNF Lifecycle Operation Granting interface”.

ETSI GS NFV-SOL 001 V3.3.1, by introducing “SoftNetworkAffinityRule” in “Policy Types”, which will be used by newly introduced “tosca.groups.nfv. NetworkPlacementGroup”.

Embodiments herein afford many advantages, of which a non-exhaustive list of examples follows. In some embodiments herein, the proposed solution can ensure that more VMs are scheduled on the same compute node or compute nodes under the same bottom-tier (e.g., leaf) switch. In some embodiments herein, the proposed solution can ensure that more internal traffic will go through shortest path or shorter path, which mean better network quality. In some embodiments herein, the proposed solution can ensure that the least total network cost (distance) are involved in VNF internal traffic. In some embodiments herein, by invoking network cost (distance) scoring algorithm, the first network node such as VIM can instantiate VMs on proper compute nodes to reduce the overall workload on network devices, reduce the average VNF internal traffic latency, and finally optimize whole VNF network quality. The embodiments herein are not limited to the features and advantages mentioned above. A person skilled in the art will recognize additional features and advantages upon reading the following detailed description.

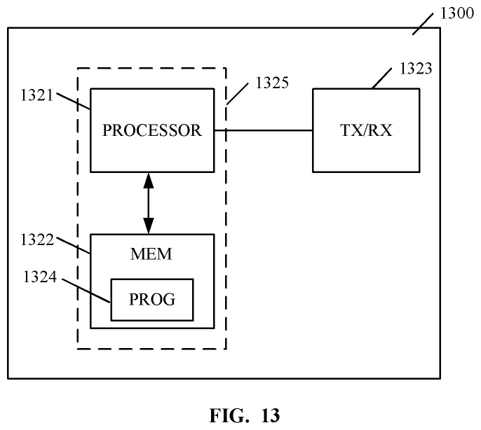

FIG. 13 is a block diagram showing an apparatus suitable for practicing some embodiments of the disclosure. For example, any one of the first network node or the second network node described above may be implemented as or through the apparatus 1300.

The apparatus 1300 comprises at least one processor 1321, such as a digital processor (DP), and at least one memory (MEM) 1322 coupled to the processor 1321. The apparatus 1300 may further comprise a transmitter TX and receiver RX 1323 coupled to the processor 1321. The MEM 1322 stores a program (PROG) 1324. The PROG 1324 may include instructions that, when executed on the associated processor 1321, enable the apparatus 1300 to operate in accordance with the embodiments of the present disclosure. A combination of the at least one processor 1321 and the at least one MEM 1322 may form processing means 1325 adapted to implement various embodiments of the present disclosure.

Various embodiments of the present disclosure may be implemented by computer program executable by one or more of the processor 1321, software, firmware, hardware or in a combination thereof.

The MEM 1322 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1321 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first network node, the memory 1322 contains instructions executable by the processor 1321, whereby the first network node operates according to any step of the methods related to the first network node as described above.

In an embodiment where the apparatus is implemented as or at the second network node, the memory 1322 contains instructions executable by the processor 1321, whereby the second network node operates according to any step of the methods related to the second network node as described above.

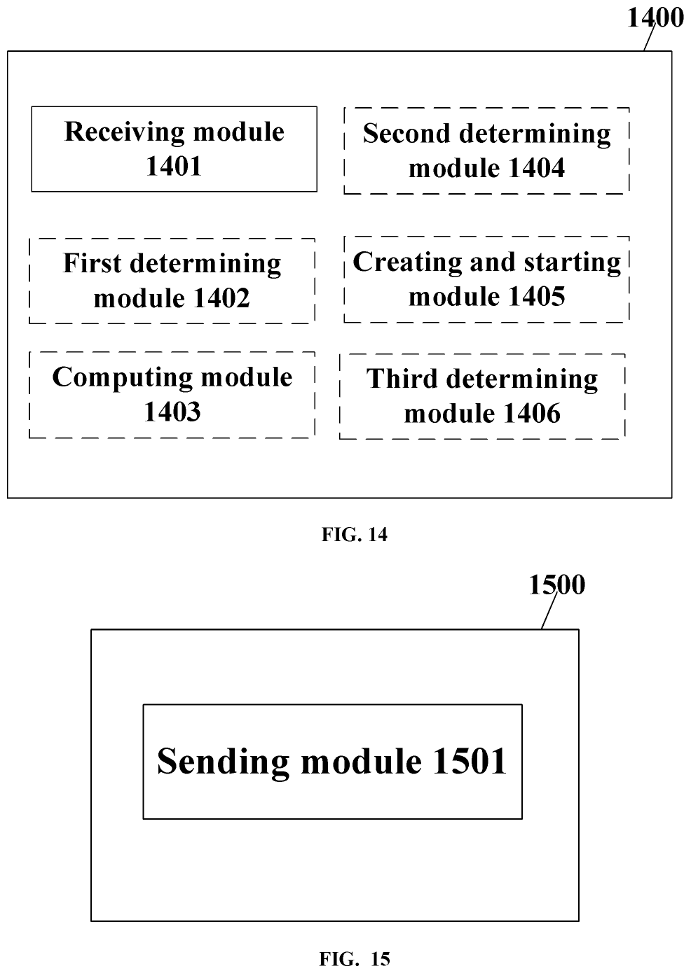

FIG. 14 is a block diagram showing a first network node according to an embodiment of the disclosure. As shown, the first network node 1400 comprises a receiving module 1401 configured to receive a request for creating and starting a virtual machine (VM) in a network from a second network node. The request comprises at least one group identifier.

In an embodiment, the first network node 1400 further comprises a first determining module 1402 configured to determine at least one compute node that has instantiated at least one VM in at least one group identified by the at least one group identifier based on the at least one group identifier.

In an embodiment, the first network node 1400 further comprises a computing module 1403 configured to compute a total network cost between a candidate compute node and the at least one compute node.

In an embodiment, the first network node 1400 further comprises a second determining module 1404 configured to determine a compute node from one or more candidate compute nodes to instantiate the VM based on respective total network costs computed for each of the one or more candidate compute nodes.

In an embodiment, the first network node 1400 further comprises a creating and starting module 1405 configured to create and start the VM on a compute node.

In an embodiment, the first network node 1400 further comprises a third determining module 1406 configured to determine one from one or more candidate compute nodes to instantiate the VM when the VM is a first VM to be instantiated in at least one group identified by the at least one group identifier.

FIG. 15 is a block diagram showing a second network node according to an embodiment of the disclosure. As shown, the second network node 1500 comprises a sending module 1501 configured to send a request for creating and starting a virtual machine (VM) in a network to a first network node. The request comprises at least one group identifier.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first network node or the second network node may not need a fixed processor or memory, any computing resource and storage resource may be arranged from the first network node or the second network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-30. (canceled)

31. A method performed by a first network node, the method comprising:
receiving from a second network node a request for creating and starting a virtual machine (VM) in a network, wherein the request comprises at least one group identifier.

32. The method according to claim 31, further comprising, based on the at least one group identifier, determining a compute node to instantiate the VM.

33. The method according to claim 31, further comprising:
determining at least one compute node that has instantiated at least one VM in at least one group identified by the at least one group identifier;
computing respective total network costs between one or more candidate compute nodes and the at least one compute node; and
determining a compute node, from the one or more candidate compute nodes, to instantiate the VM based on the respective total network costs computed for the one or more candidate compute nodes.

34. The method according to claim 33, wherein the total network cost between the determined compute node and the at least one compute node is lowest among the respective total network costs computed for the one or more candidate compute nodes.

35. The method according to claim 33, wherein each total network cost computed for a candidate compute node is a weighted sum of network costs between the candidate compute node and a plurality of other compute nodes.

36. The method according to claim 33, wherein the total network cost is based on at least one of the following: a total network distance, a total network latency, or total network resource consumption.

37. The method according to claim 31, further comprising, when the VM is an initial VM to be instantiated in at least one group identified by the at least one group identifier, randomly selecting a compute node to instantiate the VM, from one or more candidate compute nodes.

38. The method according to claim 31, further comprising creating and starting the VM on a compute node, in accordance with the request.

39. The method according to claim 31, wherein at least one group identified by the at least one group identifier is a network affinity group.

40. The method according to claim 39, wherein there is heavy internal traffic among the VMs in the network affinity group.

41. The method according to claim 31, wherein one or more of the following applies:
the network comprises a data center network, and the network comprises a spine-and-leaf network.

42. The method according to claim 32, wherein the determined compute node is a candidate compute node that satisfies at least one predefined condition.

43. The method according to claim 42, wherein the at least one predefined condition comprises at least one of the following: a resource requirement, an affinity policy, and an anti-affinity policy.

44. The method according to claim 31, wherein one or more of the following applies:
the second network node is or comprises a Network Functions Virtualization Orchestrator or a Virtual Network Function manager; and
the first network node is or comprises a Virtualized Infrastructure Manager.

45. A method performed by a second network node, the method comprising:
sending to a first network node a request for creating and starting a virtual machine (VM) in a network, wherein the request comprises at least one group identifier.

46. The method according to claim 45, wherein the at least one group identifier indicates that the first network node should determine a compute node to instantiate the VM.

47. The method according to claim 45, wherein:
at least one group identified by the at least one group identifier is a network affinity group; and
there is heavy internal traffic among the VMs in the network affinity group.

48. The method according to claim 45, wherein one or more of the following applies:
the network comprises a data center network, and the network comprises a spine-and-leaf network.

49. The method according to claim 45, wherein one or more of the following applies:
the second network node is or comprises a Network Functions Virtualization Orchestrator or a Virtual Network Function manager; and
the first network node is or comprises a Virtualized Infrastructure Manager.

50. A first network node comprising:
a processor; and
a memory coupled to the processor, said memory containing instructions executable by said processor, whereby said first network node is operative to:
receive from a second network node a request for creating and starting a virtual machine (VM) in a network, wherein the request comprises at least one group identifier.
